(19) United States
(12) Patent Application Publication
(10) Pub. No.: US 2017/0215004 A1
(43) Pub. Date: Jul. 27, 2017

(54) Speaker Power Supplies

(71) Applicant: Mission Cables, LLC, Ravensdale, WA (US)

(72) Inventor: Brian Jeffrey Wengreen, Ravensdale, WA (US)

(21) Appl. No.: 15/413,028

(22) Filed: Jan. 23, 2017

Related U.S. Application Data
(60) Provisional application No. 62/286,093, filed on Jan. 22, 2016.

(51) Int. Cl. H04R 3/00; H02J 7/00; H04R 1/02

(52) U.S. Cl. CPC H04R 3/00; H04R 1/026; H04R 1/025; H02J 7/0045; H02J 7/0047; H02J 7/0029; H02J 7/0054; H04R 2420/09; H02J 2007/004

(57) ABSTRACT

Speaker power systems can provide electricity to an audio speaker device that does not have an internal battery to transform the speaker device from a power-outlet dependent device to a mobile device. Speaker power systems can include a housing configured to couple to a lower portion of the speaker device, a battery located in the housing, and an electrical cable configured to provide the electricity from the battery to the speaker device.

### CROSS REFERENCE TO RELATED APPLICATIONS

This application claims the benefit and priority of U.S. Provisional Patent Application No. 62/286,093; filed Jan. 22, 2016; and entitled SPEAKER POWER SUPPLIES; the entire contents of which are incorporated herein by reference.

### BACKGROUND

Field

Various embodiments disclosed herein relate to audio speakers. Certain embodiments relate to speaker power supplies.

Description of Related Art

Audio speaker devices can emit sounds, such as music. Speakers typically require electricity, which is often supplied to a speaker by an electrical cord plugged into a power outlet. The electrical cord plugged into the power outlet prevents the speaker from being a mobile device (because the electrical cord tethers the speaker to the power outlet). Thus, there is a need for systems that transform the speaker from a power-outlet dependent device to a mobile device.

### SUMMARY

Speaker power systems can provide electricity to an audio speaker device that does not have an internal battery configured to enable playing music. Thus, speaker power systems can transform the speaker device from a power-outlet dependent device to a mobile device. Speaker power systems can include a housing configured to couple to a lower portion of the speaker device, a battery located in the housing, and an electrical cable configured to provide the electricity from the battery to the speaker device.

In some embodiments, a speaker power system comprises a cylindrical clamp having at least a first sidewall, a second sidewall, and a third sidewall. The sidewalls can be separated from each other by openings configured to allow the sidewalls to flex outward in response to inserting the lower portion of the speaker device into an area between the sidewalls. The cylindrical clamp can be configured such that the sidewalls flexing outward creates a compressive force on the lower portion of the speaker device to mechanically couple the speaker power system to the speaker device.

In several embodiments, the cylindrical clamp couples to a vertical sidewall of the speaker device such that at least 75 percent of the sidewall of the speaker device is located outside of the speaker power system.

In some embodiments, a speaker power system comprises a cylindrical liner located in the area between the sidewalls such that the cylindrical liner is compressed between the sidewalls and the speaker device when the lower portion of the speaker device is located in the area between the sidewalls.

In several embodiments, the sidewalls are molded from a first material, and the cylindrical liner is molded from a second material that is softer than the first material such that the cylindrical liner is configured to conform to exterior features of the speaker device. The sidewalls can be configured to maintain a compressive force on the cylindrical liner and the speaker device to prevent the speaker power system from falling off the speaker device.

In some embodiments, a housing of a speaker power system is cylindrical. The housing can comprise a cylindrical sidewall that extends upward around the lower portion of the speaker device. The system can further comprise a cylindrical liner located adjacent to an interior surface of the sidewall. The cylindrical liner can be located between the sidewall and the lower portion of the speaker device.

In several embodiments, the sidewall is molded from a first material, and the cylindrical liner is molded from a second material that is softer than the first material such that the cylindrical liner is configured to deform in response to inserting the lower portion of the speaker device into an interior area of the cylindrical liner. Deformation of at least a portion of the cylindrical liner can create a compressive force on the speaker device to prevent the speaker power system from falling off the speaker device. The liner can comprise at least two ribs that protrude at least one of radially inward and radially outward.

In some embodiments, the speaker power system couples to a sidewall (e.g., a vertical sidewall) of the speaker device such that at least 75 percent of the sidewall of the speaker device is located outside of the speaker power system.

In several embodiments, the first electrical cable of the speaker power system comprises a flexible portion that is at least 20 millimeters long. The flexible portion can protrude from a lid of the housing. The lid can be located between the cylindrical liner and the battery. The first electrical cable can pass through a first channel in the lid. The first electrical cable can pass through a second channel in the cylindrical liner. A distal end of the first electrical cable can comprises an electrical plug coupled with an electrical port of the speaker device inside the interior area of the cylindrical liner such that the electrical plug is hidden between the speaker power system and the speaker device.

In some embodiments, a housing of a speaker power system comprises sidewalls that extend upward away from the housing and away from the battery such that the sidewalls are configured to wrap at least partially around an outer perimeter of the speaker device. The sidewalls can be separated from each other by openings configured to allow the sidewalls to flex outward in response to inserting the lower portion of the speaker device into an area between the sidewalls. The openings can be vertical slots such that a distance between adjacent sidewalls is less than 15 millimeters. The sidewalls can be curved to form a cylindrical shape (e.g., with or without breaks to facilitate sidewall flexing).

In several embodiments, the sidewalls cover less than 25 percent of the outer perimeter of the speaker device such that at least a majority of sound exit holes of the speaker device are not covered by the speaker power system.

In some embodiments, a speaker power system comprises a cylindrical liner that wraps around the outer perimeter of the speaker device such that the cylindrical liner is compressed between the sidewalls and the speaker device in the area between the sidewalls. The sidewalls can be molded from a first material. The cylindrical liner can be molded from a second material that is softer than the first material such that the cylindrical liner is configured to conform to response to being compressed between the sidewalls and the speaker device. The sidewalls can be configured to maintain a compressive force on the cylindrical liner and the speaker device to prevent the speaker power system from falling off the speaker device.

In several embodiments, the housing comprises a cylindrical outer wall that wraps around a perimeter of the housing. The sidewalls can be located around the perimeter of the housing. The battery can be located within the cylindrical outer wall under the cylindrical liner.

In several embodiments, the housing comprises a lid located between the cylindrical liner and the battery. The first electrical cable can pass through a first channel in the lid. The first electrical cable can pass through a second channel in the cylindrical liner. A distal end of the first electrical cable can comprise an electrical plug coupled with an electrical port of the speaker device inside the area between the sidewalls such that the electrical plug is hidden between the speaker power system and the speaker device.

In some embodiments, the housing comprises sidewalls that extend upward away from the housing to form a cylindrical clamp such that the sidewalls wrap at least partially around an outer perimeter of the speaker device and apply a compressive force on the outer perimeter of the speaker device to removably couple the speaker power system to the lower portion.

In several embodiments, a speaker power system can comprise an electrical port located on an outer surface of the housing. The electrical port can be configured to be electrically coupled to a power supply cable that provides the electricity to the speaker power system. The electrical port can be electrically coupled to a power control system located within the housing. The power control system can electrically couple the battery and to the speaker device.

In some embodiments, the power control system is configured to simultaneously charge the battery and provide a first electrical power to the speaker device in response to receiving the electricity from the power supply cable.

In several embodiments, the power control system is configured to stop supplying the electricity from the battery to the speaker device in response to a charge of the battery falling below a first threshold that is greater than or equal to an audio degradation threshold such that the speaker power system prevents insufficient battery power from causing audio degradation.

In some embodiments, the power control system comprises a first indicator light that illuminates in response to the speaker power system providing the electricity to the speaker device. The power control system can comprise a second indicator light that illuminates in response to speaker power system receiving a second electrical power from the electrical port.

In some embodiments, a speaker power system comprises sidewalls that are separated from each other by openings (e.g., slots less than 10 millimeters wide). The speaker power system can further comprise a cylindrical liner that wraps around the outer perimeter of the speaker device such that the cylindrical liner is compressed between the sidewalls and the speaker device. The sidewalls can be molded from a first material. The cylindrical liner can be molded from a second material that is softer than the first material such that the cylindrical liner is configured to conform to response to being compressed between the sidewalls and the speaker device. The sidewalls can be configured to maintain a compressive force on the cylindrical liner and the speaker device to prevent the speaker power system from falling off the speaker device. The liner can comprise at least one rib that protrudes radially outward into at least one of the openings such that the rib is configured to prevent the liner from rotating relative to the housing.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a perspective view of a speaker device just before it is coupled to a power system, according to some embodiments.

FIG. 2 illustrates a perspective view of a speaker device tilted away from the power system to show the bottom of the speaker device, according to some embodiments.

FIG. 3 illustrates a side view of the power system held onto the speaker device by a clamp, according to some embodiments.

FIG. 4 illustrates a perspective view of the power system, according to some embodiments.

FIG. 5 illustrates a perspective view of a liner removed from a housing, according to some embodiments.

FIG. 6 illustrates a side view in which the housing has been hidden to facilitate viewing electrical components, according to some embodiments.

FIGS. 7 and 8 illustrate perspective views of the components shown in FIG. 6, according to some embodiments.

FIGS. 9 and 10 illustrate perspective views of the housing, according to some embodiments.

FIG. 11 illustrates a top view of the power system, according to some embodiments.

FIG. 12 illustrates a side view of the power system, according to some embodiments.

FIG. 13 illustrates a cross-sectional view taken along line A-A in FIG. 12, according to some embodiments.

FIG. 14 illustrates an enlarged view of the portion of FIG. 13 indicated by circle B, according to some embodiments.

FIG. 15 illustrates a top view of a liner with compliant ribs that protrude radially inward, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

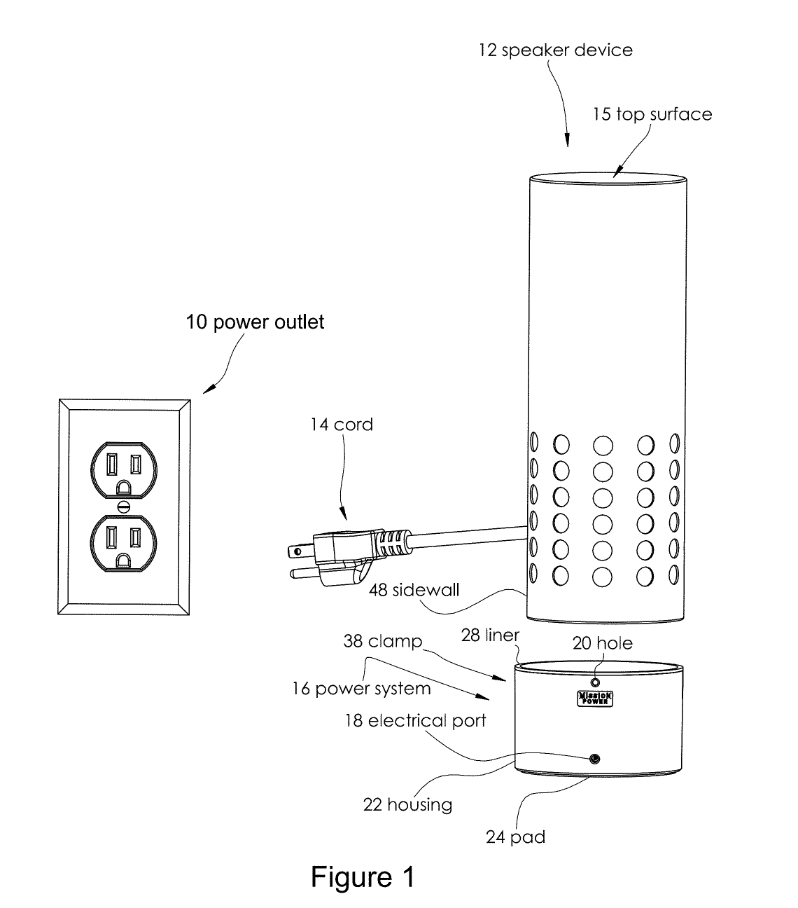

Referring now to FIG. 1, speaker devices 12 have generally been non-portable (i.e. powered by AC power outlets 10) due to the power levels required to support high-end audio as well as the “always on” nature of speaker devices 12 with language-recognition capabilities.

Many embodiments described herein give users of non-portable speaker devices 12 the option of making their devices portable via an attachable power system 16. This power system 16 is easily attachable to the non-portable speaker device 12, but is also secure to prevent inadvertent detachment. Various structures described herein enable this convenient, reliable, and removable attachment.

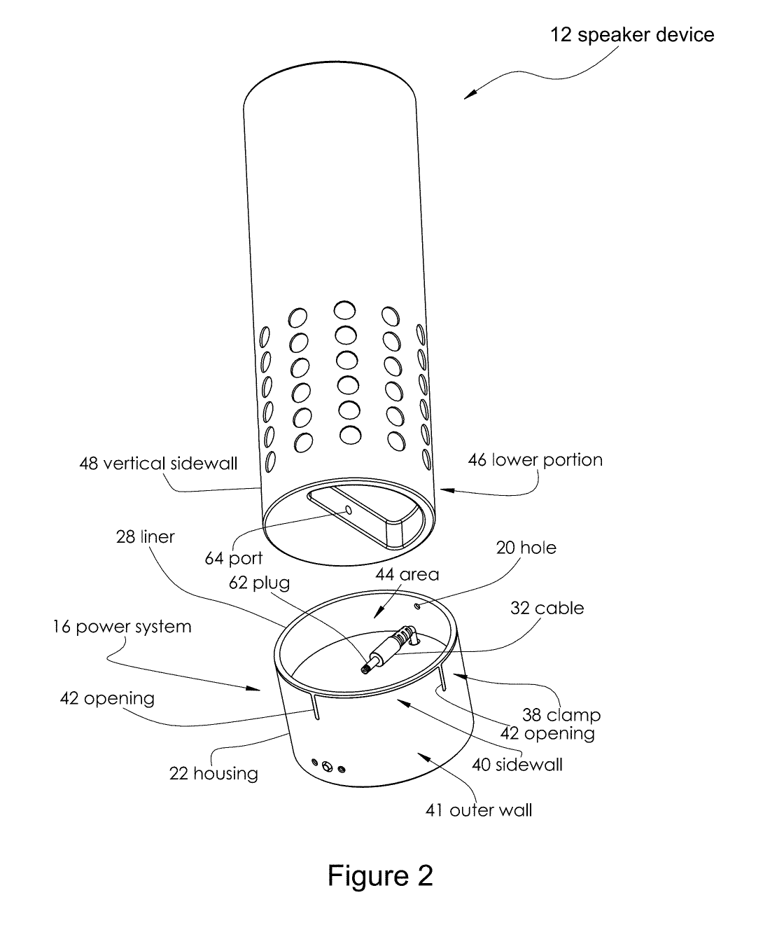

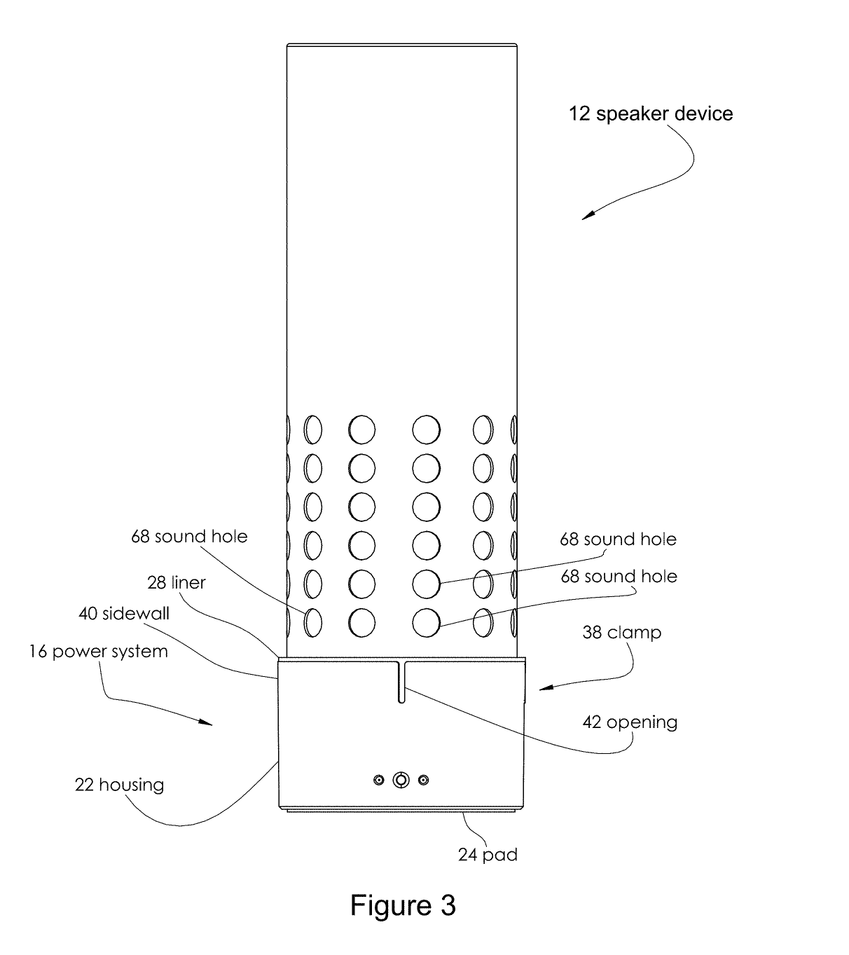

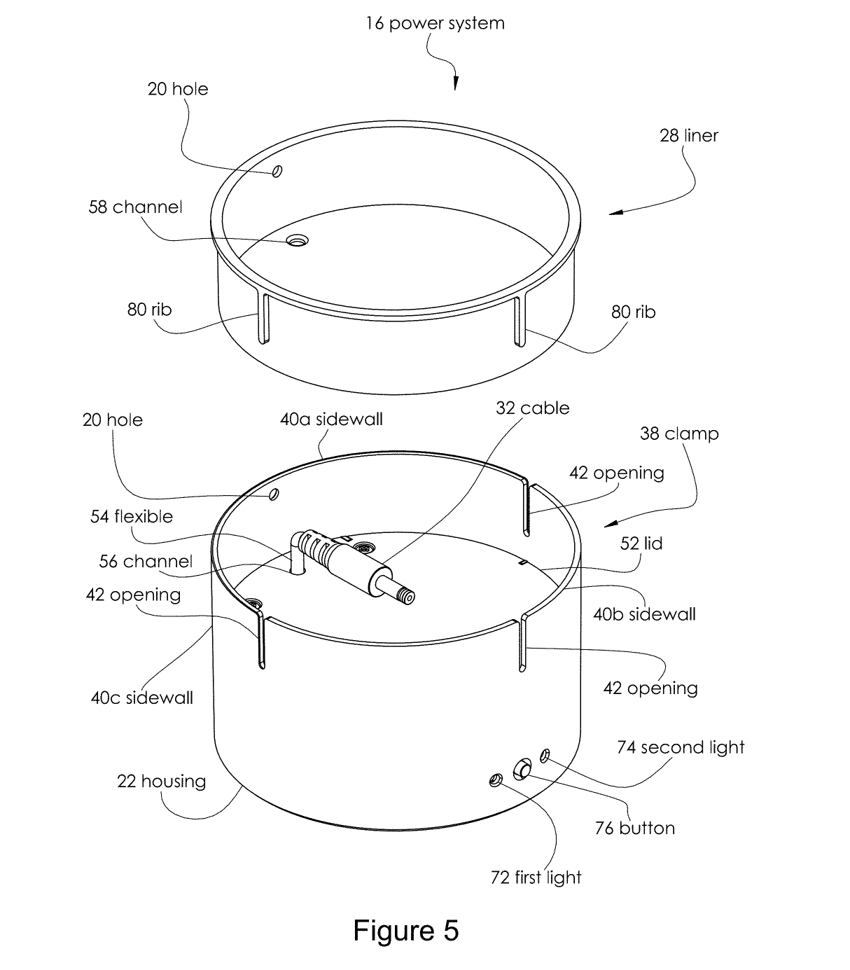

Referring now to FIG. 3, the power system 16 could easily fall off the speaker device 12 without the assistance of the clamp 38, which is explained in more detail below. Sidewalls of the speaker device 12 can be vertical such that the power system 16 is prone to fall off the speaker device 12 and be damaged with the clamp 38. In many embodiments, the clamp 38 is cylindrical which enables reliably holding onto otherwise slick sidewalls of the speaker device 12 due to compressive forces, hoop strength, and deformation of sidewalls 40, 40a, 40b, 40c, ribs 80, 80a, and/or liners 28, 28a (shown in FIG. 5). In many embodiments, the clamp 38 does not wrap around a top surface 15 of the speaker device 12, but instead squeezes a lower portion 46 (labeled in FIG. 2) of the speaker device 12.

The power system 16 also electrically integrates with the speaker device 12 in a fashion that is easy to operate and provides a seamless user experience. For example, in many embodiments, the speaker device 12 does not shut down and restart each time a power cord 14 is unplugged from the power outlet 10 and the system switches over to battery power.

Various embodiments, including electrical and mechanical components, provide an easy-to-attach, intelligent battery system that allows the user to seamlessly use the speaker device 12 in portable and non-portable conditions. For example, the user can plug the 14 from the speaker device 12 into an electrical port 18 of the power system 16 to charge a battery of the power system 16 and to provide electricity to the speaker device 12. Unplugging the cord 14 from the power outlet 10 and/or from the electrical port 18 causes the power system 16 to continue providing electricity to the speaker device 12 without electrical interruption. (Speaker devices 12 can turn off or restart in response to electrical interruptions, so the continuous power supply of many embodiments provides a superior user experience than would be the case if the system failed to supply electricity during a power source transition.)

Some audio speaker devices 12 do not have an internal battery configured to enable playing music. (In some cases, the speaker device 12 includes a small internal battery for tasks that require very little power, such as for a clock, but does not have an internal battery configured to play music). A power cord 14 can electrically couple the speaker device 12 to a power outlet 10 on a wall of a building. The power cord 14 can provide sufficient electricity to enable the speaker device 12 to play music and other sounds. In some embodiments, the speaker device 12 can also listen for audio commands such as, “Play Guardians of the Galaxy soundtrack.”

The speaker device 12 can be an Amazon Echo made by Amazon.com, Inc. The speaker device 12 can be a cylinder. Other types of speaker devices 12 can also be used embodiments of speaker power systems 16.

Speaker power systems 16 can provide electricity to an audio speaker device 12 that does not have an internal battery configured to enable playing music. Thus, speaker power systems 16 can transform the speaker device 12 from a power-outlet dependent device to a mobile device. (As used herein, “mobile device” means a device that can operate without being electrically coupled to a power outlet 10.)

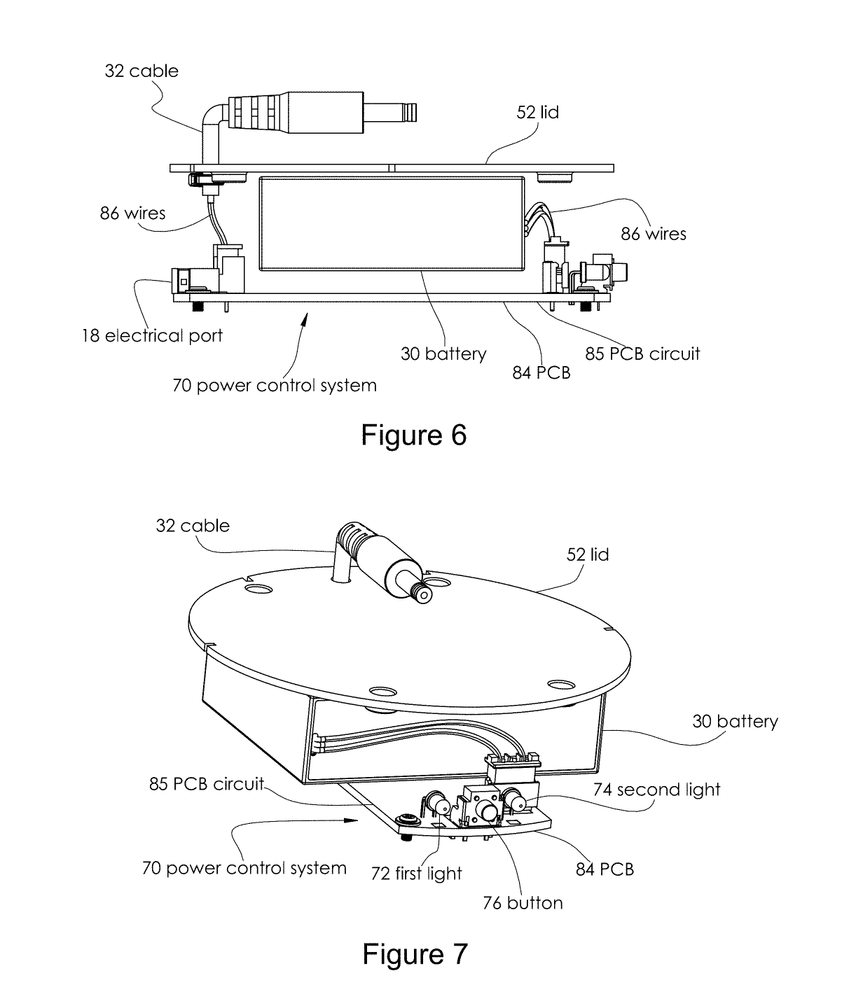

Referring now to FIG. 2, speaker power systems 16 can include a housing 22 configured to couple to a lower portion 46 of the speaker device 12. An electrical cable 32 is configured to provide the electricity from the battery 30 (shown in FIG. 6) to the speaker device 12. The housing 22 and the pad 24 are hidden in FIG. 6 to show the power control system 70 and the battery 30, which are located within the housing 22.

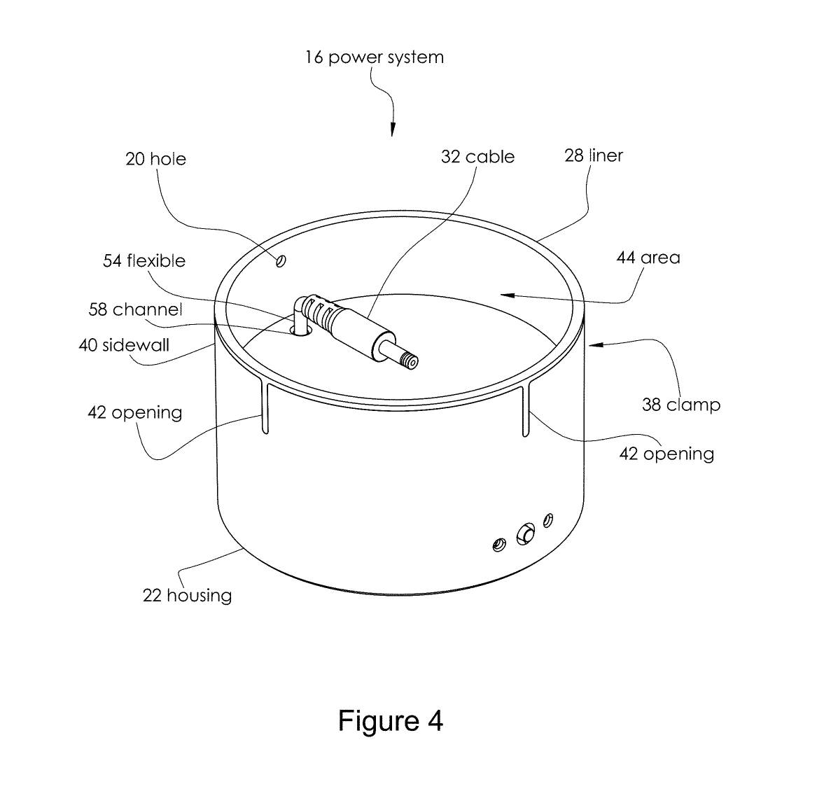

Referring now to FIG. 5, in some embodiments, a speaker power system 16 comprises a cylindrical clamp 38 having at least a first sidewall 40a, a second sidewall 40b, and a third sidewall 40c (which form a cylindrical shape with a hollow center). The sidewalls 40a, 40b, 40c can be separated from each other by openings 42 configured to allow the sidewalls 40a, 40b, 40c to flex outward in response to inserting the lower portion 46 (shown in FIG. 2) of the speaker device 12 into an area 44 (labeled in FIG. 4) between the sidewalls 40a, 40b, 40c. The cylindrical clamp 38 can be configured such that the sidewalls 40a, 40b, 40c flexing outward creates a compressive force on the lower portion 46 of the speaker device 12 (shown in FIG. 2) to mechanically couple the speaker power system 16 to the speaker device 12.

Referring now to FIG. 1, the speaker device 12 can include an indicator light. The housing 22 and/or the liner 28 can include a hole 20 (shown in FIG. 1) aligned with the indicator light of the speaker device 12 (such that the indicator light is visible when the speaker power system 16 is coupled to the speaker device 12).

A rubber pad 24 (e.g., a pad configured to prevent the housing 22 from sliding too easily) can be coupled to the bottom of the housing 22. The pad 24 can be molded from silicone.

In several embodiments, the cylindrical clamp 38 couples to a vertical sidewall 48 of the speaker device 12 such that at least 75 percent of the sidewall of the speaker device 12 is located outside of the speaker power system 16 (e.g., as shown in FIG. 3).

Referring now to FIG. 4, a speaker power system 16 can comprise a cylindrical liner 28 located in the area 44 between the sidewalls 40 such that the cylindrical liner 28 is compressed between the sidewalls 40 and the speaker device 12 (shown in FIG. 2) when the lower portion 46 of the speaker device 12 is located in the area 44 between the sidewalls (e.g., as shown in FIG. 3).

The housing 22 (including the sidewalls 40) can be molded from acrylonitrile butadiene styrene (“ABS”) and/or polycarbonate (“PC”). The liner 28 can be molded from a softer material such as silicone, which tends to be more compliant than ABS or PC.

In several embodiments, the sidewalls 40 are molded from a first material, and the cylindrical liner 28 is molded from a second material that is softer than the first material such that the cylindrical liner 28 is configured to conform to exterior features of the speaker device 12 (shown in FIG. 1). The sidewalls 40 can be configured to maintain a compressive force on the cylindrical liner 28 and the speaker device 12 to prevent the speaker power system 16 from falling off the speaker device 12 (e.g., due to gravity).

In some embodiments, a housing 22 of a speaker power system 16 is cylindrical. The housing 22 can comprise a cylindrical sidewall 40 that extends upward around the lower portion of the speaker device 12. The power system 16 can further comprise a cylindrical liner 28 located adjacent to an interior surface of the sidewall 40. As shown in FIG. 3, the cylindrical liner 28 can be located between the sidewall 40 and the lower portion of the speaker device 12.

In several embodiments, the sidewall 40 is molded from a first material, and the cylindrical liner 28 is molded from a second material that is softer than the first material such that the cylindrical liner 28 is configured to deform in response to inserting the lower portion 46 of the speaker device 12 into an interior area of the cylindrical liner 28. Deformation of at least a portion of the cylindrical liner 28 can create a compressive force on the speaker device 12 to prevent the speaker power system 16 from falling off the speaker device 12.

As shown in FIGS. 2 and 3, the speaker power system 16 couples to a sidewall 48 (e.g., a vertical sidewall) of the speaker device 12 such that at least 75 percent of the sidewall of the speaker device 12 is located outside of the speaker power system 16.

FIG. 4 illustrates a perspective view of the liner 28 fully seated in the housing 22. FIG. 5 illustrates a perspective view of the liner 28 removed from the housing 22, which reveals the lid 52.

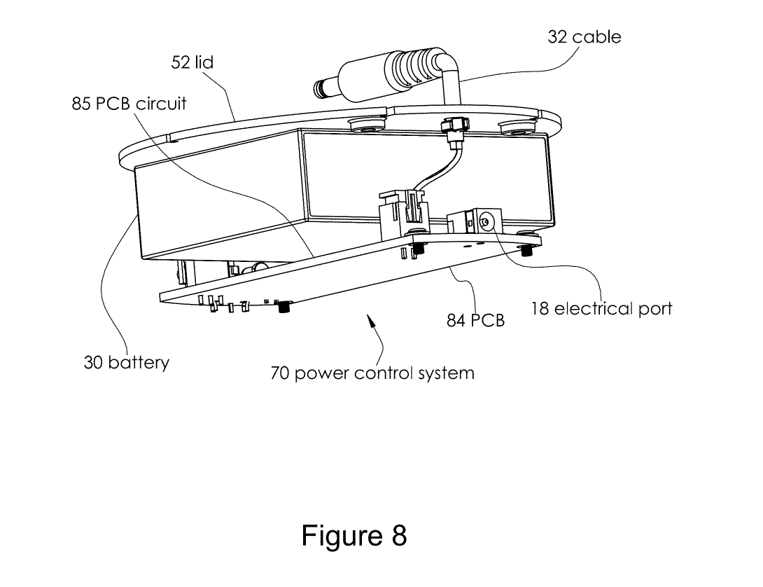

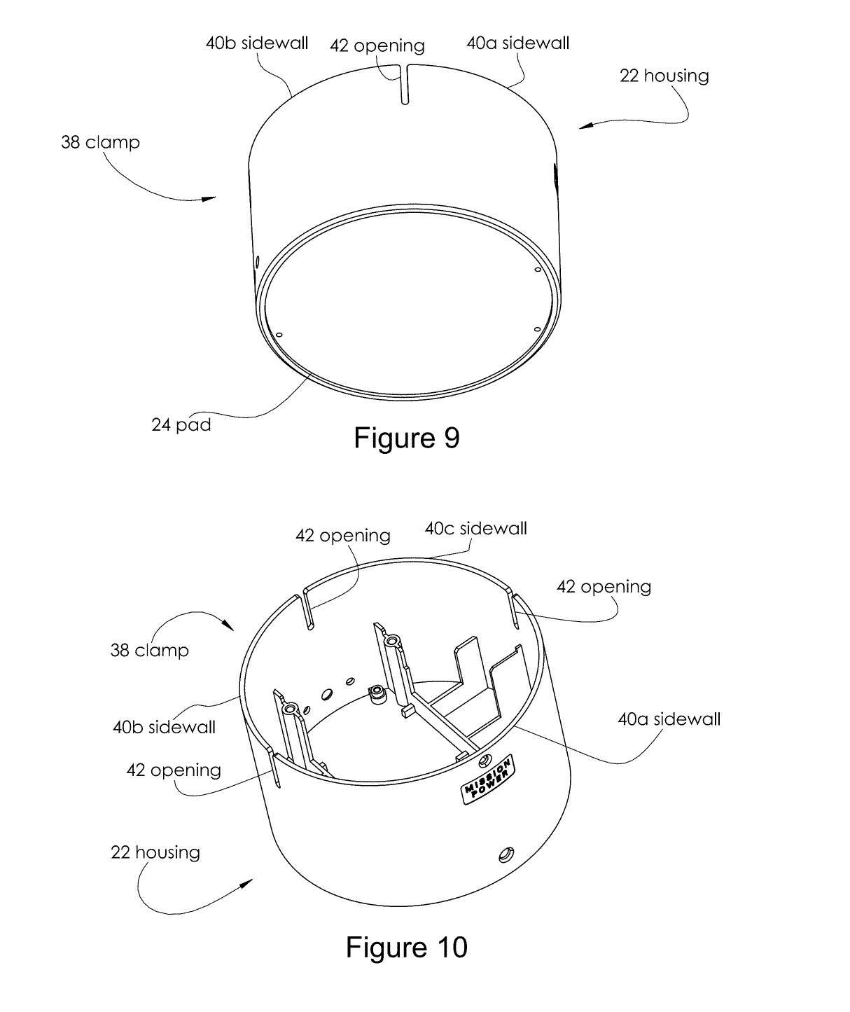

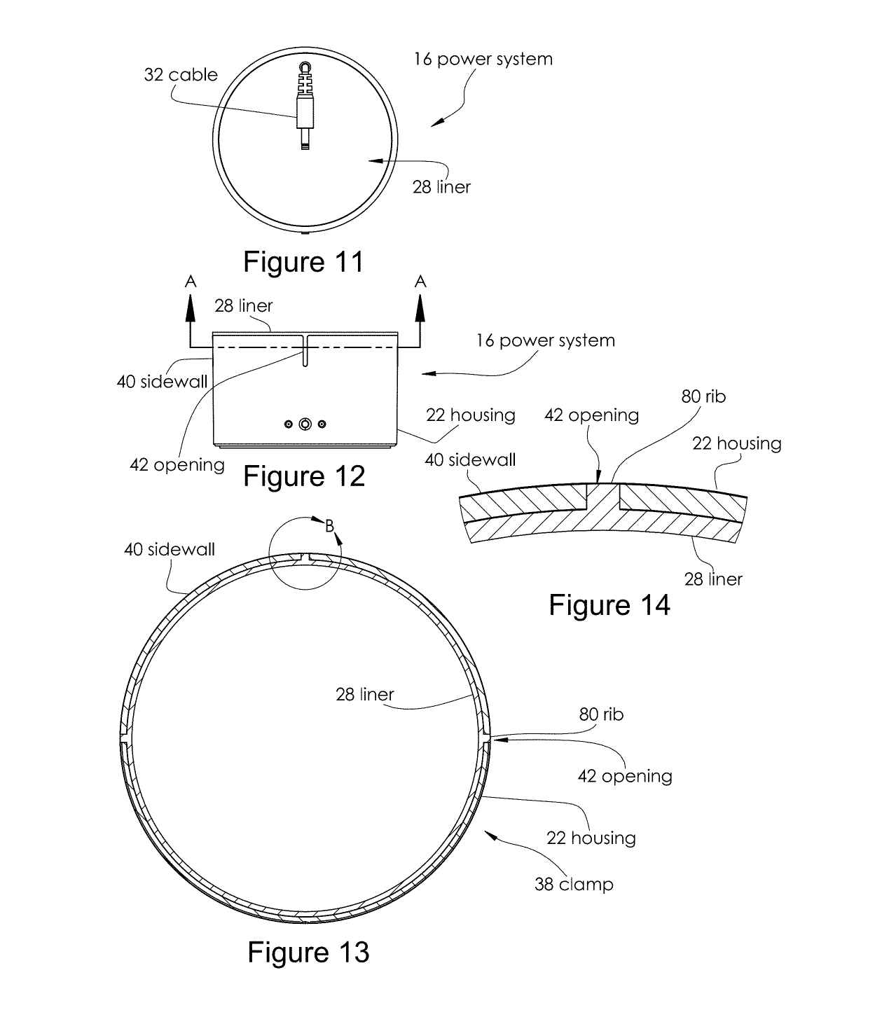

Referring now to FIGS. 4 and 5, in several embodiments, the first electrical cable 32 of the speaker power system 16 comprises a flexible portion 54 that is at least 20 millimeters long. The flexible portion 54 can protrude from a lid 52 of the housing 22. The lid 52 can be located between the cylindrical liner 28 and the battery 30 (shown in FIG. 8). The first electrical cable 32 can pass through a first channel 56 in the lid 52. The first electrical cable 32 can pass through a second channel 58 in the cylindrical liner 28.

Referring now to FIGS. 2 and 3, a distal end of the first electrical cable 32 can comprise an electrical plug 62 coupled with an electrical port 64 of the speaker device 12 inside the interior area of the cylindrical liner 28 such that the electrical plug 62 is hidden between the speaker power system 16 and the speaker device 12.

In some embodiments, a housing 22 of a speaker power system 16 comprises sidewalls 40 that extend upward away from the housing 22 and away from the battery 30 (shown in FIG. 6) such that the sidewalls 40 are configured to wrap at least partially around an outer perimeter of the speaker device 12. The sidewalls 40 can be separated from each other by openings 42 configured to allow the sidewalls 40 to flex outward in response to inserting the lower portion 46 of the speaker device 12 into an area 44 between the sidewalls 40. The openings 42 can be vertical slots such that a distance between adjacent sidewalls is less than 15 millimeters. The sidewalls 40 can be curved to form a cylindrical shape (e.g., with or without breaks to facilitate sidewall flexing). The cylindrical shape formed by the sidewalls 40 can be hollow. A portion 46 of the speaker device 12 can be placed in the hollow area formed by the sidewalls 40.

In several embodiments, the sidewalls cover less than 25 percent of the outer perimeter of the speaker device 12 such that at least a majority of sound exits holes 68 of the speaker device 12 are not covered by the speaker power system 16. (To increase the clarity of the Figures, only a few of the circular sound exit holes 68 are labeled.)

In some embodiments, a speaker power system 16 comprises a cylindrical liner 28 that wraps around the outer perimeter of the speaker device 12 such that the cylindrical liner 28 is compressed between the sidewalls 40 and the speaker device 12 in the area 44 between the sidewalls 40. The sidewalls 40 can be molded from a first material. The cylindrical liner 28 can be molded from a second material that is softer than the first material such that the cylindrical liner 28 is configured to conform to response to being compressed between the sidewalls 40 and the speaker device 12. The sidewalls 40 can be configured to maintain a compressive force on the cylindrical liner 28 and the speaker device 12 to prevent the speaker power system 16 from inadvertently falling off the speaker device 12 (e.g., due to gravity). The compressive force can be high enough to resist gravity and low enough to enable a user to pull the power system 16 off the speaker device 12.

In several embodiments, the housing 22 comprises a cylindrical outer wall 41 that wraps around a perimeter of the housing 22. The sidewalls 40 can be located around the perimeter of the housing 22. The battery 30 (shown in FIG. 6) can be located within the cylindrical outer wall 41 under the cylindrical liner 28.

Referring now to FIGS. 4 and 5, in several embodiments, the housing 22 comprises a lid 52 located between the cylindrical liner 28 and the battery 30. The first electrical cable 32 can pass through a first channel 56 in the lid 52. The first electrical cable 32 can pass through a second channel 58 in the cylindrical liner 28.

In some embodiments, the housing 22 comprises sidewalls 40a, 40b, 40c that extend upward away from the housing 22 to form a cylindrical clamp 38 such that the sidewalls 40a, 40b, 40c wrap at least partially around an outer perimeter of the speaker device 12 and apply a compressive force on the outer perimeter of the speaker device 12 (shown in FIG. 3) to removably couple the speaker power system 16 to the lower portion 46 (labeled in FIG. 2).

In some embodiments, a speaker power system 16 comprises sidewalls 40a, 40b, 40c that are separated from each other by openings 42 (e.g., slots less than 10 millimeters wide). The speaker power system 16 can further comprise a cylindrical liner 28 that wraps around the outer perimeter of the speaker device 12 such that the cylindrical liner 28 is compressed between the sidewalls and the speaker device 12 (as shown in FIG. 3). The sidewalls 40a, 40b, 40c can be molded from a first material. The cylindrical liner 28 can be molded from a second material that is softer than the first material such that the cylindrical liner 28 is configured to conform to response to being compressed between the sidewalls 40a, 40b, 40c and the speaker device 12. The sidewalls 40a, 40b, 40c can be configured to maintain a compressive force on the cylindrical liner 28 and the speaker device 12 to prevent the speaker power system 16 from falling off the speaker device 12.

FIG. 12 is a side view. FIG. 13 is a cross-sectional view taken along line A-A in FIG. 12. FIG. 14 shows the portion of FIG. 13 indicated by circle B. FIG. 14 illustrates a liner 28 that comprises a one rib 80 that protrudes radially outward into an opening 42 such that the rib 80 is configured to prevent the liner 28 from rotating relative to the housing 22. Thus, the rib 80 and the opening 42 form an interlock configured to align the channels 56, 58 shown in FIG. 5 to enable the cable 32 to pass through the channels 56, 58.

The ribs 80 shown in FIG. 5 are configured to slide into the openings 42 shown in FIG. 5 to form the assembly shown in FIG. 4. Referring now to FIGS. 2, 4, 5, and 14, the liner 28 comprises at least two ribs 80 that protrude at least one of radially inward and radially outward (relative to a central axis of the housing 22). The speaker power system 16 can couple to a sidewall 48 of the speaker device 12. The speaker power system 16 can be configured such that at least 75 percent of the sidewall of the speaker device 12 is located outside of the speaker power system 16 (as shown in FIG. 3).

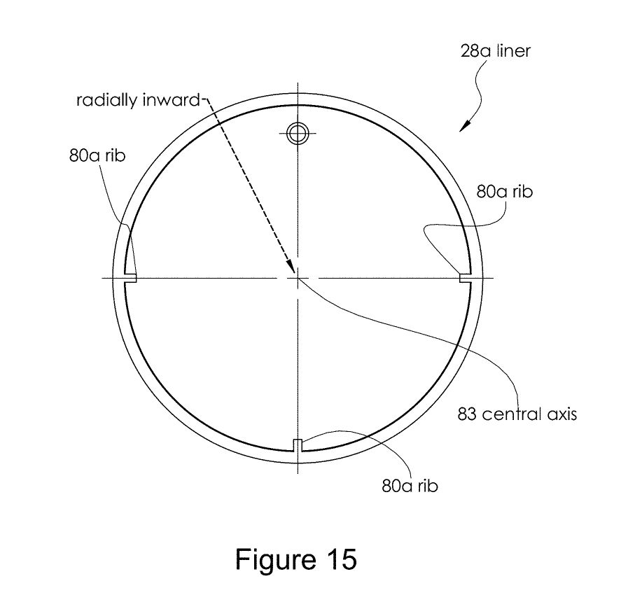

FIG. 15 illustrates a top view of a liner 28a that is identical to the liner 28 shown in FIG. 5 except that the liner 28a includes ribs 80a that protrude radially inward towards a central axis 83 of the liner 28a and/or of the power system (shown in FIG. 4). A broken line in FIG. 15 illustrates an example radially inward direction (e.g., towards the central axis 83). The ribs 80, 80a shown in FIGS. 5 and 15 can be compliant (e.g., they can be configured to deform in response to inserting the speaker device 12 into a portion of the power system 16). This deformation can create a frictional force that couples the power system 16 to the speaker device 12. In some embodiments, the liner 28, 28a is molded rubber.

Referring now to FIGS. 1 and 6, in several embodiments, a speaker power system 16 can comprise an electrical port 18 located on an outer surface of the housing 22. The electrical port 18 can be configured to be electrically coupled to a power supply cable 14 that provides the electricity to the speaker power system 16.

The electrical port 18 can be electrically coupled to a power control system 70 located within the housing 22. The power control system 70 can electrically couple the battery 30 and to the speaker device 12.

Wires 86 can electrically couple various components. Wires 86 can electrically couple the power control system 70 to the battery 30. Wires can electrically couple the power control system 70 to the cable 32, which can be electrically coupled to the speaker device 12.

In some embodiments, the power control system 70 (shown in FIG. 6 and located inside the housing 22) is configured to simultaneously charge the battery 30 and provide a first electrical power to the speaker device 12 in response to receiving the electricity from the power supply cable 14.

The power supply cable 14 may include a power adapter that converts an approximately 120 volt output of the power outlet 10 to approximately an input voltage recommended by the manufacturer of the speaker device 12 (e.g., approximately 15 volts). The speaker device 12 can be configured to operate normally when it received the input voltage. When the battery 30 supplies electricity to the speaker device 12, the input voltage supplied by the battery 30 can be influenced by a charge level of the battery 30. The power system 16 can be configured to supply the recommended input voltage when the battery 30 is fully charged. As the battery charge level is reduced (e.g., by supplying electricity from the battery 30 to the speaker device 12 without recharging the battery 30), the output voltage of the battery 30 may be reduced until the output voltage is so low that it negatively affects the sound output of the speaker device 12. Rather than continuing to supply electricity to the speaker device 12, the power system 16 can be configured to stop supplying electricity to the speaker device 12 in response to a battery charge level following below an audio degradation threshold (e.g., a voltage, a current, a power). In some embodiments, the audio degradation threshold is 9.9 volts plus two volts and/or minus three volts. Thus, the power system 16 can avoid poor audio performance of the speaker device 12 (but stopping the supply of electricity to preclude the speaker device 12 from emitting sound during a period when the speaker device 12 would otherwise receive too little power to perform properly).

In several embodiments, the power control system 70 is configured to stop supplying the electricity from the battery 30 to the speaker device 12 in response to a charge of the battery 30 falling below a first threshold that is greater than or equal to an audio degradation threshold such that the speaker power system 16 prevents insufficient battery power from causing audio degradation.

Referring now to FIGS. 5 and 7, in some embodiments, the power control system 70 comprises a first indicator light 72 that illuminates in response to the speaker power system 16 providing the electricity to the speaker device 12. The power control system 70 can comprise a second indicator light 74 that illuminates in response to speaker power system 16 receiving a second electrical power from the electrical port 18.

A button 76 can be used to turn the system on and off. In some embodiments, pressing the button 76 causes the power system 16 to stop supplying electricity to the speaker device 12, but the power system 16 stays “on” (e.g., so the power system 16 can charge the battery 30 without supplying power to the speaker device 12).

The power control system 70 can comprise a printed circuit board 84, which can include components that are typically electrically coupled to a printed circuit board 84. The power control system 70 can comprise light emitting diodes, capacitors, resistors, memory systems, wires, electrical interconnects, batteries (e.g., lithium batteries), battery terminals, software, processors, comparators, transistors, logic integrated circuits, and computers.

The power control system 70 can comprise direct current (“DC”) power input and output ports. (Alternating current is herein abbreviated as “AC.”) The DC input port is designed to be compatible (both mechanically and electrically) with the Amazon Echo 12 AC/DC power adapter. The DC output port is designed such that it mechanically and electrically connects to the power port 64 on the speaker device 12 (shown in FIG. 2).

The power control system 70 can comprise a PCB circuit 85 designed to handle two different power paths. The first path is the power coming from the external speaker device 12 AC/DC adapter (e.g., 14 in FIG. 1) and the second path is the power coming into and out of the battery 30. There is protection built into this second power path to prevent current from inadvertently flowing from the battery 30 back into the speaker device 12 AC/DC power adapter (e.g., 14 in FIG. 1). This protection circuit also can shut off the flow of current into the battery 30 in the event that a user connects an incompatible AC/DC adapter into the power system 16. The power path also controls the flow of current into and out of the battery 30 based on the overall power status of the system. If there is excess power available from the AC/DC adapter 14, beyond what is needed by the speaker device 12, the power path will steer current into the battery 30 in order to charge it. If there is a shortage of power (e.g., there is no AC/DC adapter present), the power path will steer current from the battery 30 into the speaker device 12, thus ensuring that the speaker device 12 always has sufficient power and thus ensuring that the user can seamlessly switch between battery 30 and power from the power outlet 10 without any resets or shutdowns.

The PCB circuit 85 includes an advanced battery management integrated circuit whose function is to control the power path, properly charge and discharge the battery 30, and ensure that the system 16 always operates in a safe domain. The safety functions performed by the system 16 include ensuring the battery 30 temperature is maintained within a predetermined safe range, ensuring the voltage and current applied to the battery 30 is within a predetermined range, and ensuring that the current pulled from the AC/DC adapter 14 never exceeds its rated value. Any fault condition is conveyed to the user via an external battery 30 charging indicator light emitting diode (“LED” 72, 74 in FIGS. 5 and 7).

The PCB circuit 85 includes monitoring circuitry that serves to warn the user when the battery 30 is getting low and should soon be recharged. Monitoring circuitry of the PCB circuit 85 also monitors the battery charge level to ensure that the system 16 is properly shutdown prior to any audio degradation (e.g., a click or popping sound that could otherwise be heard by the user when the supply voltage to the speaker device 12 is insufficient to properly support the audio levels) or prior to deeply discharging the battery 30 (e.g., discharging the battery 30 below a predetermined voltage threshold), which can damage the battery 30.

The PCB circuit 85 includes a shutdown device that can isolate the speaker device 12 from the battery 30 based on input from a battery monitoring subsystem of the PCB circuit 85.

The PCB circuit 85 includes a subsystem that controls two LEDs 72, 76 (shown in FIGS. 5 and 7) that communicate information about the status of the power system 16 to the user. The PCB circuit 85 also includes an on/off switch 76 (shown in FIGS. 5 and 7) that the user can press to shut down the speaker device 12 in order to save power and extend the life of the battery 30.

The system can include a 3-cell lithium polymer rechargeable battery 30. The 3-cell battery 30 stack can outputs voltage of 9.7 volts to 12.6 volts, which is the optimal voltage range to provide to the speaker device 12 (with enough voltage headroom to drive the high performance speakers). In some embodiments, the battery 30 outputs at least 6 volts and/or less than 16 volts.

The power system 16 adds a battery 30 and electronics (as explained above) in between the speaker device's power adapter (e.g., 14 in FIG. 1) and the speaker device 12. The power system 16 is able to intelligently monitor the power available from the speaker device's AC/DC adapter 14 and properly ration the power out between the battery 30 and the speaker device 12. The power system 16 is able to seamlessly switch between battery 30 and AC/DC power (from the power outlet 10) without causing the speaker device 12 to be reset or shutdown. The power system 16 also provides an exterior switch 76 (shown in FIG. 5) whereby the user can manually turn speaker device 12 on and off. The power system 16 is able to automatically shut itself off prior to the battery 30 voltage dropping to the point at which the audio quality of the speaker device 12 is degraded.

The battery monitor includes two precision comparator circuits that are constantly checking the battery voltage and outputting a corresponding control signal to the low battery LED controller and the system shutdown block. Some hysteresis is included in the precision shutdown comparator so that the system doesn't rapidly turn on and off as the battery voltage nears the shutdown voltage threshold thus preventing chattering in the control signal that is output to the system shutdown block.

The PCB circuit 85 is important for at least two reasons. First, PCB circuit 85 serves to warn the user that the battery 30 is near the end of its useable range and should soon be recharged. The PCB circuit 85 also includes a precision threshold that is specially tuned to ensure that the speaker device 12 is shutdown prior to any degradation in the audio that can result from there being insufficient voltage headroom to drive the speakers. The absence of this precision monitoring and shutdown system would result in clicking or popping sounds prior to the battery 30 reaching its end of life charge.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A speaker power system configured to provide electricity to an audio speaker device that does not have an internal battery configured to enable playing music, the speaker power system comprising:
a housing configured to couple to a lower portion of the speaker device;
a battery located in the housing; and
a first electrical cable configured to provide the electricity from the battery to the speaker device to transform the speaker device from a power-outlet dependent device to a mobile device.

2. The speaker power system of claim 1, further comprising a cylindrical clamp having at least a first sidewall, a second sidewall, and a third sidewall,
wherein the sidewalls are separated from each other by openings configured to allow the sidewalls to flex outward in response to inserting the lower portion of the speaker device into an area between the sidewalls,
wherein the cylindrical clamp is configured such that the sidewalls flexing outward creates a compressive force on the lower portion of the speaker device to mechanically couple the speaker power system to the speaker device.

3. The speaker power system of claim 2, wherein the cylindrical clamp couples to a vertical sidewall of the speaker device such that at least 75 percent of the sidewall of the speaker device is located outside of the speaker power system.

4. The speaker power system of claim 2, further comprising a cylindrical liner located in the area between the sidewalls such that the cylindrical liner is compressed between the sidewalls and the speaker device when the lower portion of the speaker device is located in the area between the sidewalls.

5. The speaker power system of claim 4, wherein the sidewalls are molded from a first material, and the cylindrical liner is molded from a second material that is softer than the first material such that the cylindrical liner is configured to conform to exterior features of the speaker device, and the sidewalls are configured to maintain a compressive force on the cylindrical liner and the speaker device to prevent the speaker power system from falling off the speaker device.

6. The speaker power system of claim 1, wherein the housing is cylindrical and comprises a cylindrical sidewall that extends upward around the lower portion of the speaker device, the system further comprising a cylindrical liner located adjacent to an interior surface of the sidewall, and located between the sidewall and the lower portion of the speaker device,
wherein the sidewall is molded from a first material, and the cylindrical liner is molded from a second material that is softer than the first material such that the cylindrical liner is configured to deform in response to inserting the lower portion of the speaker device into an interior area of the cylindrical liner, wherein deformation of at least a portion of the cylindrical liner creates a compressive force on the speaker device to prevent the speaker power system from falling off the speaker device.

7. The speaker power system of claim 6, wherein the liner comprises at least two ribs that protrude at least one of radially inward and radially outward, the speaker power system couples to a sidewall of the speaker device, and the speaker power system is configured such that at least 75 percent of the sidewall of the speaker device is located outside of the speaker power system.

8. The speaker power system of claim 6, wherein the first electrical cable comprises a flexible portion that is at least 20 millimeters long, the flexible portion protruding from a lid of the housing, wherein the lid is located between the cylindrical liner and the battery, the first electrical cable passes through a first channel in the lid, the first electrical cable passes through a second channel in the cylindrical liner, and a distal end of the first electrical cable comprises an electrical plug coupled with an electrical port of the speaker device inside the interior area of the cylindrical liner such that the electrical plug is hidden between the speaker power system and the speaker device.

9. The speaker power system of claim 1, wherein the housing comprises sidewalls that extend upward away from the housing and from the battery such that the sidewalls are configured to wrap at least partially around an outer perimeter of the speaker device,
the sidewalls are separated from each other by openings configured to allow the sidewalls to flex outward in response to inserting the lower portion of the speaker device into an area between the sidewalls, and
the sidewalls cover less than 25 percent of the outer perimeter of the speaker device such that at least a majority of sound exit holes of the speaker device are not covered by the speaker power system.

10. The speaker power system of claim 9, wherein the openings are vertical slots such that a distance between adjacent sidewalls is less than 15 millimeters, and wherein the sidewalls are curved to form a cylindrical shape.

11. The speaker power system of claim 9, further comprising a cylindrical liner that wraps around the outer perimeter of the speaker device such that the cylindrical liner is compressed between the sidewalls and the speaker device in the area between the sidewalls.

12. The speaker power system of claim 11, wherein the sidewalls are molded from a first material, and the cylindrical liner is molded from a second material that is softer than the first material such that the cylindrical liner is configured to conform to response to being compressed between the sidewalls and the speaker device, and the sidewalls are configured to maintain a compressive force on the cylindrical liner and the speaker device to prevent the speaker power system from falling off the speaker device.

13. The speaker power system of claim 11, wherein the housing comprises a cylindrical outer wall that wraps around a perimeter of the housing, the sidewalls are located around the perimeter of the housing, and the battery is located within the cylindrical outer wall under the cylindrical liner.

14. The speaker power system of claim 13, wherein the housing further comprises a lid located between the cylindrical liner and the battery, the first electrical cable passes through a first channel in the lid, the first electrical cable passes through a second channel in the cylindrical liner, and a distal end of the first electrical cable comprises an electrical plug coupled with an electrical port of the speaker device inside the area between the sidewalls such that the electrical plug is hidden between the speaker power system and the speaker device.

15. The speaker power system of claim 1, wherein the housing comprises sidewalls that extend upward away from the housing to form a cylindrical clamp such that the sidewalls wrap at least partially around an outer perimeter of the speaker device to apply a compressive force on the outer perimeter of the speaker device to removably couple the speaker power system to the lower portion.

16. The speaker power system of claim 15, wherein the sidewalls are separated from each other by openings,
the speaker power system further comprising a cylindrical liner that wraps around the outer perimeter of the speaker device such that the cylindrical liner is compressed between the sidewalls and the speaker device,
wherein the sidewalls are molded from a first material, and the cylindrical liner is molded from a second material that is softer than the first material such that the cylindrical liner is configured to conform to response to being compressed between the sidewalls and the speaker device, and the sidewalls are configured to maintain the compressive force on the cylindrical liner and the speaker device to prevent the speaker power system from falling off the speaker device,
wherein the liner comprises at least one rib that protrudes radially outward into at least one of the openings such that the rib is configured to prevent the liner from rotating relative to the housing.

17. The speaker power system of claim 15, the system further comprising an electrical port located on an outer surface of the housing and configured to be electrically coupled to a power supply cable that provides the electricity to the speaker power system, wherein the electrical port is electrically coupled to a power control system located within the housing, wherein the power control system electrically couples the battery and to the speaker device.

18. The speaker power system of claim 16, wherein the power control system is configured to simultaneously charge the battery and provide a first electrical power to the speaker device in response to receiving the electricity from the power supply cable.

19. The speaker power system of claim 16, wherein the power control system is configured to stop supplying the electricity from the battery to the speaker device in response to a charge of the battery falling below a first threshold that is greater than or equal to an audio degradation threshold such that the speaker power system prevents insufficient battery power from causing audio degradation.

20. The speaker power system of claim 16, wherein the power control system comprises a first indicator light that illuminates in response to the speaker power system providing the electricity to the speaker device, and the power control system comprises a second indicator light that illuminates in response to speaker power system receiving a second electrical power from the electrical port.
